(19) United States
(12) Patent Application Publication
(10) Pub. No.: US 2008/0116048 A1
(43) Pub. Date: May 22, 2008

(54) SWITCH UNIT OPERABLE WITH ROCKER SWITCHES FOR CONTROL UNITS

(76) Inventors: Britta Straber, Siegburg (DE); Stefan Burmeister, Kerpen (DE); Andreas Rode, Kerpen (DE)

Correspondence Address: DICKINSON WRIGHT PLLC, 1901 L. STREET NW, SUITE 800, WASHINGTON, DC, 20036, US

(21) Appl. No.: 11/876,988

(22) Filed: Oct. 23, 2007

(30) Foreign Application Priority Data
Oct. 24, 2006 (DE) 102006051028.3

(51) Int. Cl. H01H 3/00

(52) U.S. Cl. 200/339

(57) ABSTRACT

A switch unit operable with help of rocker switches for control units is disclosed herein. The switch unit is provided with a compact unit for actuating electrical contacts on circuit boards by moving push-button switches by means of push-button caps. The caps are each connected to a swiveling lever which is pivoted in a rotary bearing. Each of the swiveling levers applies mechanical pressure contact to the respective push-button switch when the respective push-button cap is rocked. The compact unit is provided with a fixed part having a circuit board. Each of the push-button switches is located sandwich-like, above and below the circuit board. The circuit board is also inserted into a groove of the rotary bearing. The compact unit is also provided with guiding parts, each itself provided with a guiding forming and a leaf spring in each guiding forming. The compact unit is also provided with a moving part in the form of the swiveling lever pivotable about the rotary bearing. The swiveling lever is divided into two tongue parts spreading V-shaped opposite to the respective push-button cap. Each of the two tongue parts extends towards an associated push-button switch. Both of the guiding formings and the leaf springs cooperate to bias the swiveling lever to an original position.

### BACKGROUND OF THE INVENTION

1. Field of the Invention

The invention relates to a switch unit operatable with help of rocker switches for control units provided with a compact unit for actuating contacts on circuit boards by moving push-button switches by means of push-button caps, which are connected each to a swiveling lever pivoted in a rotary bearing, the swiveling lever applying mechanical pressure contact to the push-button switch by rocking a push-button cap.

2. Description of Related Prior Art

Traditional switch units 1 attached at control panels 11, such as the switch unit shown in FIG. 1 in a perspective front view, particularly for HVAC controls in vehicles, are provided with several rocker switches which are equipped with neighbouring push-button caps 2, 3, 4, 5, 6 aligned along a given region of the control panel. A problem is that there are dis-placements and dislocations which distort the region, occurring as errors of alignment 7, 8, 9, 10 between the individual neighbouring push-button caps 2, 3, 4, 5, 6 of the rocker switches, these errors caused by the structure of the compact units, which are placed behind the control panel, of the rocker switches.

The associated rocker switches, equipped with the push-button caps 2, 3, 4, 5, 6 on the front of the control panel, are provided each with a sandwich-like compact unit on the back of the control panel, the compact units containing two circuit boards and push-button switches each, which can be actuated by an operator by means of a pivoted lever made of a plastic material. A leaf spring presses the plastic lever to an upper row of push-button switches which make corresponding electrical contacts on both circuit boards.

The control panel is usually realized as a hider directed towards the passenger compartment of the vehicle.

The traditional compact units are structured such that one of the circuit boards has a push-button switch at the tip on the top surface of the compact unit. The other circuit board with the other push-button switch is placed at the tip of the bottom surface at the compact unit.

The plastic lever is placed between both circuit boards and pivoted in a grooved control ring.

The point of rotation of the plastic lever is located on the opposite side of the point of operator actuation, the actuating point for the push-button switch is located between so that a very long setting depth results.

When the operator presses down the plastic lever by means of the appropriate push-button cap 2, 3, 4, 5, 6 the lower push-button switch of the compact unit is contacted. When the operator moves the same push-button cap upwards, the upper push-button switch of the com-pact unit is contacted. At the lower rest position a metal leaf spring presses the plastic lever down on to the lower push-button switch so that the rest position is defined by the top surface of the push-button switch. This means that the exact plastic lever position is influenced by the tolerances of the plastic lever itself, the tolerances of the circuit board positions and thicknesses, and the tolerances of the push-button switch thicknesses.

As the tolerances of the number of included components add up, the neighboring push-button caps 2, 3, 4, 5, 6 are offset to each other to a different extent, not being aligned correctly. This particularly shows when after having been repeatedly actuated the push-button caps due to adding up of certain tolerances are displaced from the central position originally set.

A problem is that due to the large number of tolerances brought in within the compact unit, already there the causes of the errors of alignment 7, 8, 9, 10 are present so that the push-button caps are not aligned correctly along the given region of the control panel, which is noticed even more, if neighboring push-button caps have different shapes. In addition, the errors of alignment may be not always uniform, of the same magnitude, but different from push-button cap to push-button cap.

The errors of alignment 7, 8, 9, 10 between the push-button caps 2, 3, 4, 5, 6 are easily and obviously seen. In order to eliminate the problem, already during production some of the push-button switches are provided with a tape for tolerance reduction bonded on to the top surface with the aim to minimize the respective errors of alignment 7, 8, 9, 10. So it is just a matter of time that the bonded tapes no longer fulfill their tolerance-reducing function.

The other problem of traditional controls with rocker switches is that the metal leaf spring in the compact unit influences the actuation force in such a way that the motion-force diagrams of the upward and downward directions are different.

An arrangement of switches is described in DE 196 47 946 C1, with the arrangement pro-vided for a control panel at the instrument board or the central console in a vehicle. The arrangement of switches contains a casing for at least one switch having an actuator, the switch being placed in a socket in the casing. A hider, the contour of which is curved, is attachable to the casing, whereby the hider is provided with a recess through which the actuator of the switch projects after mounting of the hider. The casing contains of at least two casing parts, each casing part being assigned to one region of the hider. The side of the casing part that is directed towards the hider is arranged about parallel to one of the plane surfaces approximating the curvature of the associated region.

Another arrangement of switching elements is described in DE 43 38 829 C2, the arrangement provided with a basic body with at least one receptacle for switching elements, at least one switching element inserted into the associated receptacle in preassembled condition, with a switch cap attached to the switching element, and a cover mounted on the basic body, the cover provided with a passage hole for each switch cap, whereby after the switching element has been preassembled on the basic body and before the basic body and the cover are joined together, the switch cap is held slidable relative to the basic body in at least one direction (y-direction) vertical to the cover assembly device (z-direction), and centering means are established, on the one hand, at the switching element and, on the other hand, at the cover, that interact for centering the switch cap in the passage hole.

A problem of both known arrangements of switching elements is that the circuit boards are located with the switching elements parallel to the surface of the push-button caps.

### SUMMARY OF THE INVENTION

In summary, the invention is a switch unit operable with help of rocker switches for control units. The switch unit is provided with a compact unit for actuating electrical contacts on circuit boards by moving push-button switches by means of push-button caps. The caps are each connected to a swiveling lever which is pivoted in a rotary bearing. Each of the swiveling levers applies mechanical pressure contact to the respective push-button switch when the respective push-button cap is rocked. The compact unit is provided with a fixed part having a circuit board. Each of the push-button switches is located sandwich-like, above and below the circuit board. The circuit board is also inserted into a groove of the rotary bearing. The compact unit is also provided with guiding parts, each itself provided with a guiding forming and a leaf spring in each guiding forming. The compact unit is also provided with a moving part in the form of the swiveling lever pivotable about the rotary bearing. The swiveling lever is divided into two tongue parts spreading V-shaped opposite to the respective push-button cap. Each of the two tongue parts extends towards an associated push-button switch. Both of the guiding formings and the leaf springs cooperate to bias the swiveling lever to an original position.

### BRIEF DESCRIPTION OF THE DRAWINGS

The invention is explained in greater detail with help of an example of embodiment by means of several drawings. It is shown by:

FIG. 1 a switch unit with push-button caps at a control panel of prior art;

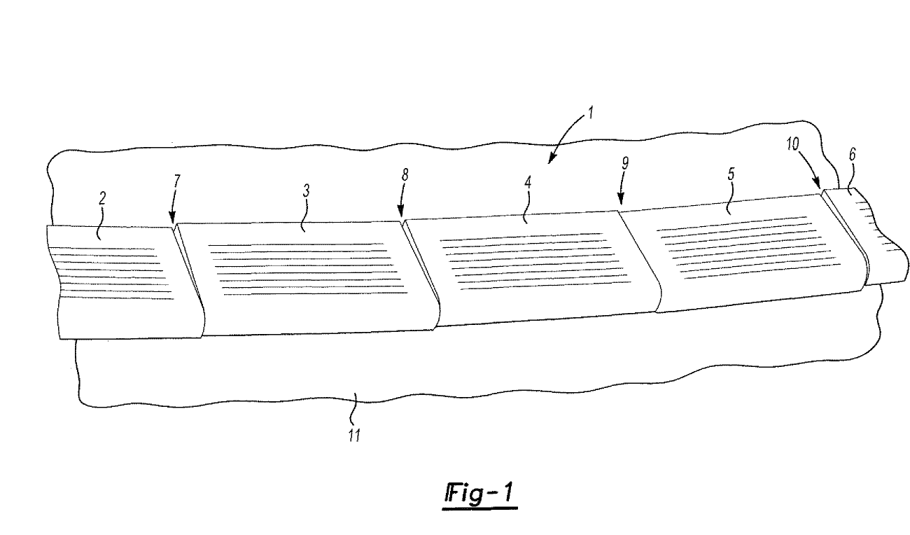

FIG. 2 a perspective representation of a rocker switch;

FIG. 3 a perspective rear representation of a compact unit accompanying the rocker switch according to FIG. 2;

FIG. 4 a longitudinal section through a rocker switch according to the invention of a switch unit;

FIG. 5 a schematic representation of switching positions of a rocker switch and the asso-ciated compact unit; and

FIG. 6 a switch unit according to the invention provided with aligned push-button caps.

### DETAILED DESCRIPTION OF AN EXEMPLARY EMBODIMENT

It is the objective of the invention to disclose a switch unit operable with help of rocker switches for control units, the switch unit established such that errors of alignment between the push-button caps of the rocker switches at the control panel are largely avoided. Further, it is intended to reduce the component expenditure in the compact units assigned to the rocker switches.

The problem of the prior art is solved by the features of claim 1. The switch unit is operable with help of rocker switches for control units is provided with a compact unit for actuating electrical contacts on circuit boards by moving push-button switches by means of push-button caps, which are connected each to a swiveling lever pivoted in a rotary bearing, the swiveling lever applying mechanical pressure contact to the push-button switch by rocking a push-button cap, the compact unit according to the characterizing part of claim 1 including a fixed part with a circuit board and a push-button switch sandwich-like located above and below, whereby the circuit board is inserted into a groove of the rotary bearing, and with a guiding part provided with a guiding forming, and a moving part with the swiveling lever pivoted in the grooved rotary bearing, the swiveling lever opposite to the push-button cap being divided into two tongue parts spreading in V-shape, which are run each to an associated push-button switch, to which in each case a free external region of a tongue part is opposite and which is provided with two leaf spring elements having a lateral spring forming, whereby the spring forming of a leaf spring element is arranged correspondingly fitted into the guiding forming of the assigned guiding part and both corresponding formings create a securing lock with respect to a given attachment position of the swiveling lever, for which the tolerances present between the two formings are set to a minimum so that after having been at a rocking position created by rocking the push-button cap the swiveling lever moves back self-aligning into the original attachment position.

The swiveling lever may be made as a plastic lever or a zinc, magnesium or aluminum lever or the like. For the higher-strength die-cast levers an accordingly corresponding spring element, even an additional one, may be used which is attached by fitting on or welding or a similar process step that creates holding.

The spring forming of the movable leaf spring elements may be a convex elastic bulge and the guiding forming of the fixed guiding part corresponding to it may be a steady concave recess.

The convex bulge and the concave recess may be V-shaped or U-shaped projections and V-shaped or U-shaped indentations as applicable in each case, arranged corresponding to each other in each case.

In another version the formings corresponding to each other may be established at the leaf spring elements and the guiding parts in reverse manner with respect to their leg-like structure or curvature.

The circuit board is centrally mounted into the groove of the grooved rotary bearing so that the upper push-button switch is mounted to the top and the lower push-button switch is mounted to the bottom of the circuit board.

The grooved rotary bearing may be a grooved control ring, whereby the guiding parts which are provided with the longitudinal forming are the fixed part of the rotary bearing.

As already mentioned above the swiveling lever can be V-shaped and established as a tongue divided into two tongue parts so that the upper tongue part is arranged opposite to the upper push-button switch, while the lower tongue part is arranged opposite to the lower push-button switch, whereby the rotary bearing of the swiveling lever is on a straight line between the user actuating point of a push-button cap and the push-button switch contact point with the respective tongue part.

The alignment of the swiveling lever is determined by the position of the corresponding formings, whereby the tolerances to be considered during manufacture of the components and assembly thereof are the tolerances of the swiveling lever itself and the tolerance of the alignment of the formings. The tolerances of the formings are minimal as no displacements of the push-button caps occur when at the attachment position the elastic spring forming contacts the stable guide forming in pre-tensioned condition.

The original or rest attachment position of the swiveling lever is therefore given by the position of the laterally disposed leaf spring elements which at their rest position are arranged opposite to each other with their projection in the indentation of the guiding part. The projection may be designed wider than the indentation in order to obtain the according holding pretension between both formings.

The alignment of the push-button caps is therefore only given by the tolerances of the swiveling lever itself and the groove of the grooved rotary bearing, where the fixed circuit board identifies itself as the counterpart to the pivoted swiveling lever. The tolerance between the grooved rotary bearing and the swiveling lever, for example in form of a plastic lever, can easily be set if also the rotary bearing is a part made of plastics.

It is an advantage of the compact assembly according to the invention that the leaf spring elements influence the actuating force uniformly in both actuating directions so that the motion-force diagrams of the lower tongue part for the upward rocking direction and of the tongue part for the downward rocking direction are identical.

Due to the sandwich-like structure the circuit board is here arranged vertical to the push-button switch surface normals.

The swiveling lever thus contains two leaf spring elements formed projecting or indenting, which are guided in the tapered off or strengthened guiding part of the grooved rotary bearing.

With the attachment of the spring forming of the leaf spring elements of the swiveling lever in the guide forming of the fixed guiding parts associated to the rotary bearing, for moving the push-button switches in direction towards the circuit board only short-time rocking of the push-button caps is required by the operator in order to edge out the swivel-ling lever over the two leaf spring elements with their spring formings from the rest attachment position and thus from the guide formings of the guiding parts at a certain angle, which creates an elastic compression of the spring forming of the leaf spring elements to snap back by itself after mechanical contacting of the protrusions of the tongue part with the respective push-button switch by the built-up compression spring force of the leaf spring elements into the guide forming of the guiding part and then to retake the original attachment position. Then the push-button cap on the front of the control panel is again in its original attachment position, without alignment deviations.

The function of alignment according to the invention is mainly influenced by the chosen material of the swiveling lever, particularly of the leaf spring elements, by the design of the leaf spring elements and associated draft/displacement angles during, for example, casting of the V-shaped indentations of the guiding parts. The permissible deformation for frequent actuation is determined by the material of the swiveling lever. After the material of the swiveling lever has been chosen, the design of the leaf spring elements can be defined: length, as well as thickness and width of the leaf spring elements. These parameters define the deflection force of the leaf spring elements just as well as the displacement angle with respect to the V-shaped indentations of the guiding parts.

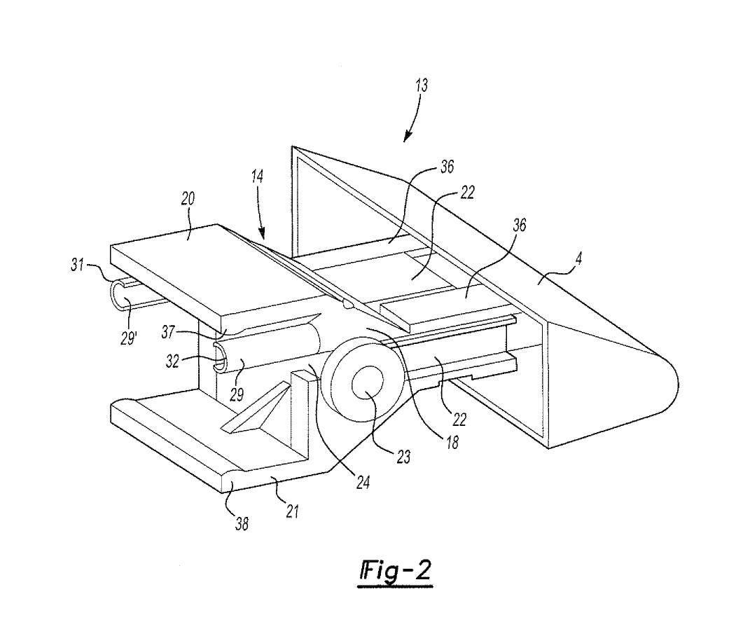

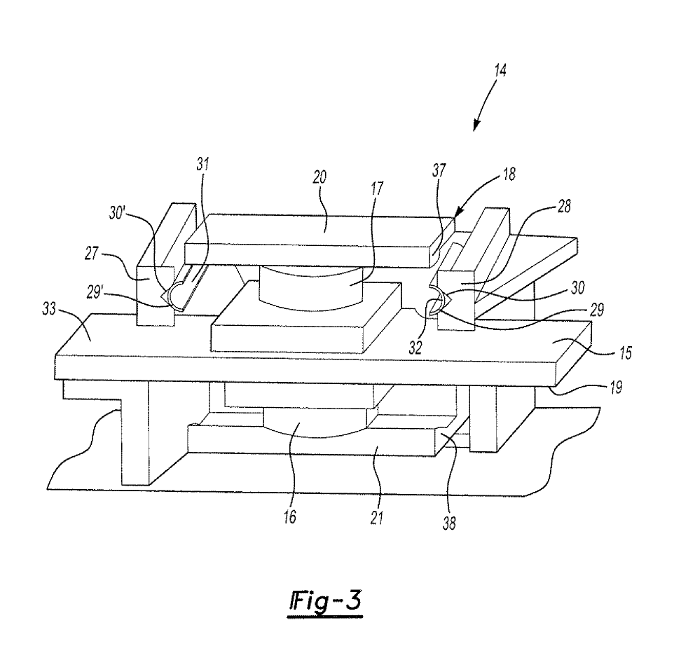

In FIGS. 2 and 3, a compact unit 14 established as rocker switch 13 is shown in the main, as could be contained within a switch unit 1 at a control panel 11 in vehicles.

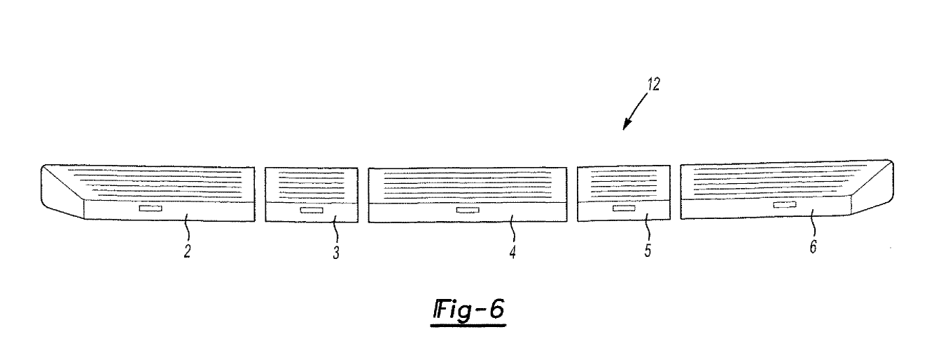

A switch unit 12 (shown in FIG. 6) operable by means of rocker switches 13 for control units is provided for each rocker switch 13 with a compact unit 14 for actuating electrical contacts on a circuit board 15 by moving push-button switches 16, 17 with help of rocking push-button caps 4, which are connected each with a swiveling lever 18 in form of a plastic lever pivoted in a rotary bearing 23, the swiveling lever 18 applying mechanical pressure contact to the associated push-button switch 16, 17 when a push-button cap 4 is rocked.

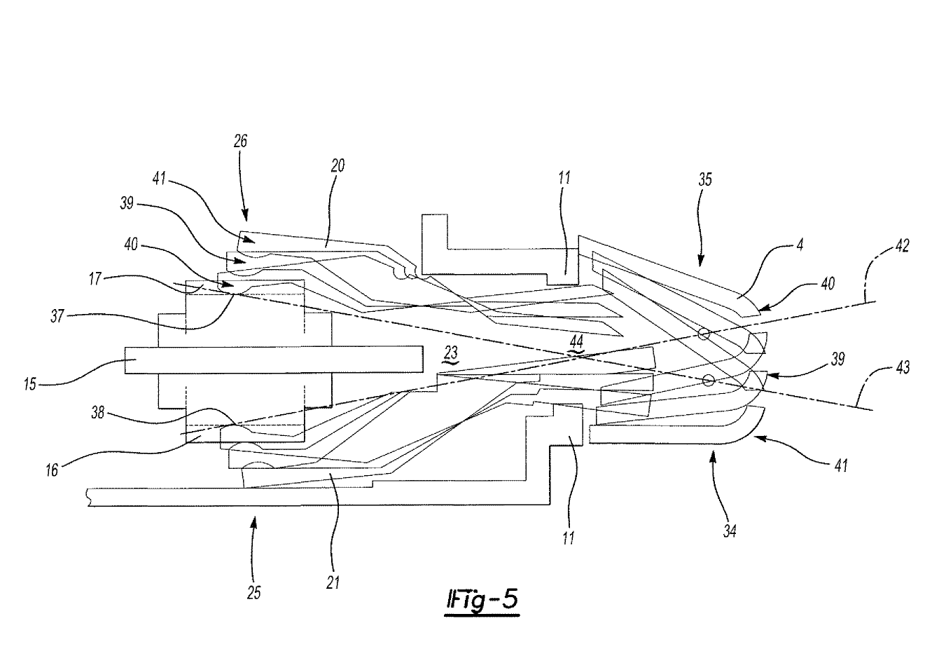

According to the invention, the compact unit 14 is provided with a fixed part having the circuit board 15 and the push-button switch 16, 17 located above and below, whereby the circuit board 15 is inserted into a groove 24 of a rotary bearing 23, and having guiding parts 27, 28 provided with a guiding forming 30, 30′, and a moving part having the plastic swiveling lever 18 pivoted in the grooved rotary bearing 23, the swiveling lever 18 opposite to the push-button cap 4 being divided into two tongue parts 20, 21 spreading V-shaped, which are run each to the associated push-button switch 16, 17 to which in each case a free external region of the tongue part 20, 21 is opposite and which is provided with two leaf spring elements 31, 32 having a lateral spring formings 29, 29′, whereby the spring formings 29, 29′ of the leaf spring elements 31, 32 are arranged correspondingly fitted into the guiding forming 30, 30′ of the assigned guiding part 27, 28 and both corresponding formings 29, 30, 29′, 30′ create a securing lock with respect to a given attachment position 39 (shown in FIG. 5) of the plastic swivelling lever 18, for which the tolerances present between the formings 29, 30, 29′, 30′ are set to a minimum so that after having been at a rocking position 40, 41 (shown in FIG. 5) created by push-button cap rocking 34, 35 (shown in FIG. 5) the plastic swivelling lever 18 moves back self-aligning into the original attachment position 39.

The same applies to the other push-button caps 2, 3, 5, 6.

The compact unit 14 presentable within the control panel 11 is provided with the circuit board 15 with the two push-button switches 16, 17, which sandwich-like enclose and are connected to the circuit board 15, and a plastic lever 18. The circuit board 15 is centrally mounted into the groove 24 of the rotary bearing 23, which is opened by the groove 24. The upper push-button switch 17 is held at the top 33 and the lower push-button switch 16 is held at the bottom 19 of the circuit board 15. The plastic lever 18 is established V-shaped with a tongue 22 divided into two tongue parts 20, 21 so that the upper tongue part 20 is arranged opposite to the upper push-button switch 17. The lower tongue part 21 is arranged opposite to the lower push-button switch 16. The rotary bearing 23 of the plastic lever 18 is located on a straight line 42, 43 between the point of the user rocking direction 34, 35 of a push-button cap 4 and the push-button switch contact point 25, 26 of the respective tongue part 20, 21 with the push-button switch surface.

The respective free end of the tongue parts 20, 21 may be provided with longitudinal noses or protrusions 37, 38 directed towards the push-button switches.

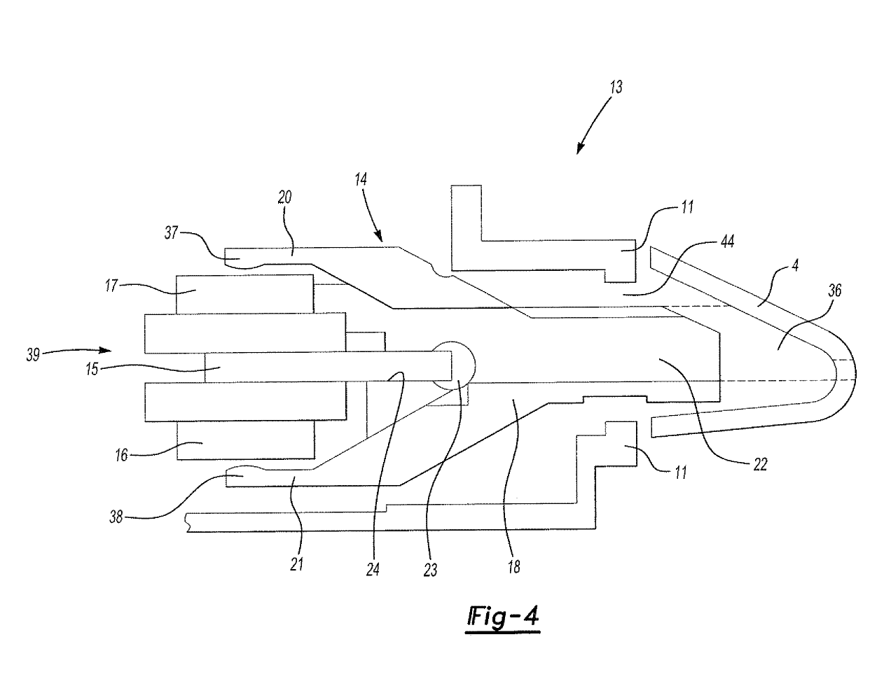

The push-button caps 2, 3, 4, 5, 6 have at least one internal fit-on unit 36, which is used to fit the push-button caps 2, 3, 4, 5, 6 on to the plastic lever 18 so that they are held there. For that, however, accordingly openings 44 are provided in the control panel 11 or the hider, respectively, through which the fit-on units 36 grip, as also shown in FIG. 4.

In FIGS. 2 and 3 two perspective representations of the compact unit are shown, whereby FIG. 2 shows the compact unit 14 without the circuit board 15 built-in and FIG. 3 shows a section of the perspective view of the compact unit 14 seen from the rear of the control panel 11.

In the area of the upper push-button switch 17, the convex leaf spring elements 31, 32 are arranged correspondingly at either side, and guiding parts 27, 28 are arranged laterally at the plastic lever 18, the guiding parts 27, 28 each provided with a V-shaped guiding forming—the recesses/indentations—30, 30′.

At either side in the upper region of the upper push-button switch 16, 17 the movable plastic lever 18 contains the convex leaf spring elements 31, 32. The leaf spring elements 31, 32 are attached with their convex bulge—an arch—in a guiding part 27, 28 provided with a V-shaped guiding forming—an indentation. The attachment position is determined by the leaf spring elements 31, 32, which are arranged centrally attached in the V-shaped indentations 30, 30′ of the guiding part 27, 28, each representing a securing lock.

As shown in FIGS. 3 and 4, the circuit board 15 is fixed in the groove 24 vertical to the push-button switch surface normal.

Following, the action of the aligned push-button caps 2, 3, 4, 5, 6 at the control panel 11 is explained in detail.

In rest attachment position 39, the projections 29, 29′ of the leaf spring elements 31, 32 are in force-closed and nearly form-closed contact with the indentations 30, 30′ of the guiding parts 27, 28.

If the user presses down the plastic lever 18—rocking direction 35 in FIG. 5, at rocking position 41—the lower push-button switch 16 is mechanically through contacted in direction 25; if the user pulls the plastic lever 18 upwards—rocking direction 34 in FIG. 5, at rocking position 40—the upper push-button switch 17 is also mechanically through contacted in direction 26.

When the plastic lever 18 is pressed down, the leaf spring elements 31, 32 are compressed with their arches 29, 29′ at the upper bevel of the V-shaped indentations 30, 30′. If the user pulls the plastic lever 18 upwards, the leaf spring elements 31, 32 are compressed with their arches 29, 29′ at the lower bevel of the V-shaped indentations 30, 30′ of the guide parts 27, 28. After rocking the spring forces of the leaf spring elements 31, 32 press the plastic lever 18 always into the rest attachment position 39 into the centre of the V-shaped indentations 30, 30′. The rest alignment of the plastic lever 18 is therefore defined by the position of the indentations 30, 30′. The tolerances that are inevitably obtained by calculation are the tolerance of the plastic lever 18 itself and the tolerance of the alignment of the formings 29, 30, 29′, 30′. The tolerances existing between the formings 29, 30, 29′, 30′ and the plastic lever 18 are well settable so that the neighboring push-button caps 2, 3, 4, 5, 6 are correctly aligned to each other, as is shown in FIG. 6.

The leaf spring elements 31, 32 that are guided in the guiding formings 30, 30′ are the distinctive feature compared with the traditional switch units.

The switch unit 12 of the invention is cost-effective due to the use of only one circuit board 15 and the small push-button switch tolerances. Alignment of the push-button caps 2, 3, 4, 5, 6 in the control panel region is only predetermined by the tolerances of the plastic lever 18 itself. The tolerance between the grooved rotary bearing 23 and the plastic lever 18 can easily be set.

Another advantage of the switch unit 12 is that the leaf spring elements 31, 32 exert uniform influence on the actuating force in both rocking directions 34, 35 so that the motion-force diagrams for the upward rocking direction 34 and the downward rocking direction 35 are identical.

The switch unit 12 is cost-effective also for that reason that no metallic leaf spring is required. The setting depth is accordingly small.

Generally, it can be said that the function of alignment according to the invention is mainly influenced by the chosen material of the plastic lever 18, particularly the leaf spring elements 31, 32, by the design of the leaf spring elements 31, 32, and by the associated draft/displacement angles during, for example, casting of the V-shaped indentations 30, 30′ of the guiding parts 27, 28. The permissible deformation for frequent actuation is determined by the material of the swiveling lever 18. After the material of the swiveling lever 18 has been chosen, the design of the leaf spring elements can be defined: the length of the leaf spring elements 31, 32 as well as the thickness and width of the leaf spring elements 31, 32. These parameters define the deflection force of the leaf spring elements 31, 32 just as well as the displacement angle with respect to the V-shaped indentations 30, 30′ of the guiding parts 27, 28.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A switch unit operable with help of rocker switches for control units, provided with a compact unit for actuating electrical contacts on circuit boards by moving push-button switches by means of push-button caps which are each connected to a swiveling lever which is pivoted in a rotary bearing, each of the swiveling levers applying mechanical pressure contact to the respective push-button switch when the respective push-button cap is rocked, wherein the compact unit is provided with:
a fixed part having a circuit board, each of the push-button switches being located sandwich-like above and below the circuit board, the circuit board also being inserted into a groove of the rotary bearing;
guiding parts each provided with a guiding forming and a leaf spring in each guiding forming;
a moving part in the form of the swiveling lever pivotable about the rotary bearing, the swiveling lever being divided into two tongue parts spreading V-shaped opposite to the respective push-button cap, each of the two tongue parts being run towards an associated push-button switch, both guiding formings and leaf springs biasing the swivelling lever to an original position.

2. The switch unit of claim 1 wherein the swiveling lever is formed from one of plastic, zinc, magnesium, or aluminum.

3. The switch unit of claim 1 wherein a spring forming portion of the respective leaf spring elements is an elastic convex bulge and the corresponding guiding forming is a stable concave recess of the guiding part.

4. The switch unit of claim 3 wherein the convex bulge and the concave recess are V-shaped projections and V-shaped indentations and pre-tensioned to each other.

5. The switch unit of claim 1 wherein the circuit board is centrally mounted into the groove of the rotary bearing, whereby an upper push-button switch is held at a top of the circuit board and a lower push-button switch is held at a bottom of the circuit board.

6. The switch unit of claim 1 wherein the swiveling lever is V-shaped and established as a tongue divided into two tongue parts such that an upper tongue part is arranged opposite to an upper push-button switch and a lower tongue part is arranged opposite to a lower push-button switch, wherein the rotary bearing of the swiveling lever is located on a straight line between a user actuating point of rocking directions of the push-button cap and a push-button switch contact point with the respective tongue part.

7. The switch unit of claim 1 wherein the original position of the swiveling lever is defined when the leaf spring elements are arranged opposite to each other in the guiding parts.

8. The switch unit of claim 1 wherein the leaf spring elements exert uniform influence against an actuating force in either rocking directions so that a motion-force diagram of a lower tongue part for an upward rocking direction and of an upper tongue part for a downward rocking direction are identical.

9. The switch unit of claim 1 wherein the circuit board is arranged vertical to the push-button switch surface normals.
